(19) United States
(12) Patent Application Publication
(10) Pub. No.: US 2024/0297527 A1
(43) Pub. Date: Sep. 5, 2024

(54) METHODS AND SYSTEMS FOR MONITORING AND ADJUSTING HARMONIC EMISSION LEVELS OF INDUSTRIAL LOADS

(71) Applicant: SICHUAN UNIVERSITY, Chengdu (CN)

(72) Inventors: Ying WANG, Chengdu (CN); Mengjie YU, Chengdu (CN); Xianyong XIAO, Chengdu (CN); Yunzhu CHEN, Chengdu (CN); Wenxi HU, Chengdu (CN)

(73) Assignee: SICHUAN UNIVERSITY, Chengdu (CN)

(21) Appl. No.: 18/657,736

(22) Filed: May 7, 2024

Related U.S. Application Data
(63) Continuation-in-part of application No. 18/082,626, filed on Dec. 16, 2022, now abandoned.

(30) Foreign Application Priority Data
Feb. 24, 2022 (CN) 202210172447.1

(51) Int. Cl. H02J 13/00; G06F 17/18

(52) U.S. Cl. CPC H02J 13/00002; G06F 17/18

(57) ABSTRACT

Disclosed is a system and a method for monitoring and adjusting a harmonic emission level of an industrial load. The method may include obtaining a grid load for a current time period, and determining, for each of at least one type of industrial load, a generalized probabilistic model for the industrial load by obtaining harmonic monitoring data of the industrial load at a preset frequency, determining a harmonic characteristic dataset for the industrial load, constructing an initial generalized probabilistic model for target harmonic data, and obtaining the generalized probabilistic model for the target harmonic data. The method may further include determining a harmonic impact factor of the industrial load, and in response to determining that the harmonic impact factor of the industrial load satisfies a first preset condition, generating and sending an adjustment instruction to a control device to adjust the at least one type of industrial load.

### CROSS-REFERENCE TO RELATED APPLICATIONS

This application is a continuation-in-part of U.S. application Ser. No. 18/082,626, filed on Dec. 16, 2022, which claims priority of Chinese Application No. 202210172447.1, filed on Feb. 24, 2022, the entire contents of each of which are incorporated herein by reference.

### TECHNICAL FIELD

The present disclosure relates to a field of power system electric energy quality, and in particular to methods and systems for monitoring and adjusting harmonic emission levels of industrial loads.

### BACKGROUND

With the continuous development of industrialization, the application of high-capacity, non-linear, and impact loads in power systems has greatly increased, leading to increasingly severe harmonic problems in the power systems. In order to improve the electric energy quality of the power systems, power grid companies have conducted a series of work including harmonic flow calculation, harmonic responsibility division, and harmonic resonance analysis. How to accurately model a harmonic load, evaluate an impact of the harmonic load on the overall safe operation of the power grid based on the analysis results of modeling, and adjust the harmonic load accordingly is of great significance for harmonic hazard assessment and control.

Therefore, it is desirable to provide a method and a system for monitoring and adjusting a harmonic emission level of an industrial load, which can effectively improve the accuracy and adaptability of modeling, and enhance the monitoring level and adjustment accuracy of the harmonic emission level of the industrial load.

### SUMMARY

One or more embodiment of the present disclosure provide a method for monitoring and adjusting a harmonic emission level of an industrial load. The method may be executed by a processor, and the method may include obtaining, based on a power monitoring device deployed in a target region, a grid load for a current time period, wherein at least one type of industrial load is operating in the target region, and determining, for each of the at least one type of industrial load, a generalized probabilistic model for the industrial load. The generalized probabilistic model for the industrial load may be determined through operations including: obtaining, based on a power quality monitoring device deployed at at least one preset location around the industrial load, harmonic monitoring data of the industrial load at a preset frequency, wherein the at least one preset location includes a wire coupling position of the industrial load and the preset frequency is determined based on the grid load at the current time period; determining, based on the harmonic monitoring data, a harmonic characteristic dataset for the industrial load, the harmonic characteristic dataset including at least one piece of target harmonic data; constructing an initial generalized probabilistic model for the target harmonic data; and obtaining the generalized probabilistic model for the target harmonic data by optimizing a parameter of the initial generalized probabilistic model. The method may further include: determining, based on the generalized probabilistic model for the target harmonic data, a harmonic impact factor of the industrial load; in response to determining that the harmonic impact factor of the industrial load satisfies a first preset condition, generating an adjustment instruction and sending the adjustment instruction to a control device to adjust the at least one type of industrial load operating in the target region, wherein the adjustment instruction includes a first adjustment instruction configured to control a target industrial load to reduce a count of electricity consumption devices and a second adjustment instruction configured to cut off a power supply of the target industrial load.

One or more embodiments of the present disclosure provide a system for monitoring and adjusting a harmonic emission level of an industrial load. They system may include an acquisition module, a determination module, and an adjustment module. The acquisition module may be configured to obtain, based on a power monitoring device deployed in a target region, a grid load for a current time period, wherein at least one type of industrial load is operating in the target region. The determination module may be configured to determine, for each of the at least one type of industrial load, a generalized probabilistic model for the industrial load. The determination module may include a data acquisition unit, a dataset determination unit, a model construction unit, a model determination unit, and a factor determination unit. The data acquisition unit may be configured to obtain, based on a power quality monitoring device deployed at at least one preset location around the industrial load, harmonic monitoring data of the industrial load at a preset frequency, wherein the at least one preset location includes a wire coupling position of the industrial load and the preset frequency is determined based on the grid load at the current time period. The determination dataset unit may be configured to determine, based on the harmonic monitoring data, a harmonic characteristic dataset for the industrial load, the harmonic characteristic dataset including at least one piece of target harmonic data. The model construction unit may be configured to constructing an initial generalized probabilistic model for the target harmonic data. The model determination unit may be configured to obtaining the generalized probabilistic model for the target harmonic data by optimizing a parameter of the initial generalized probabilistic model. The factor determination unit may be configured to determine, based on the generalized probabilistic model for the target harmonic data, a harmonic impact factor of the industrial load. The adjustment module may be configured to: in response to determining that the harmonic impact factor of the industrial load satisfies a first preset condition, generate an adjustment instruction and send the adjustment instruction to a control device to adjust the at least one type of industrial load operating in the target region, wherein the adjustment instruction may include a first adjustment instruction configured to control a target industrial load to reduce a count of electricity consumption devices and a second adjustment instruction configured to cut off a power supply of the target industrial load.

One or more embodiments of the present disclosure provide a device for monitoring and adjustment a harmonic emission level of an industrial load. The device may include at least one storage medium and at least one processor, wherein the at least one processor may be configured to execute the method for monitoring and adjusting the harmonic emission level of the industrial load described in the embodiments of the present disclosure.

One or more embodiments of the present disclosure provide a non-transitory computer-readable storage medium storing one or more sets of computer instructions, wherein when a computer reads the one or more sets of computer instructions from the storage medium, the computer implements the method for monitoring and adjusting the harmonic emission level of the industrial load described in the embodiments of the present disclosure.

### BRIEF DESCRIPTION OF THE DRAWINGS

The present disclosure will be further illustrated by way of exemplary embodiments, which will be described in detail with reference to the accompanying drawings. These embodiments are not limiting. In these embodiments, the same numbering indicates the same structure, wherein:

FIG. 1 is schematic diagram of exemplary modules of a system for monitoring and adjusting a harmonic emission level of an industrial load according to some embodiments of the present disclosure;

FIG. 2 is a flowchart of an exemplary process of a method for monitoring and adjusting a harmonic emission level of an industrial load according to some embodiments of the present disclosure;

FIG. 3 is a flowchart of an exemplary process of obtaining a generalized probabilistic model through parameter optimization of an initial generalized probabilistic model according to some embodiments of the present disclosure;

FIG. 4 is a basic flowchart of an exemplary process of a multiplier technique according to some embodiments of the present disclosure;

FIG. 5 is a schematic diagram of an exemplary prediction model according to some embodiments of the present disclosure; and

FIG. 6 is a graph of measured data of harmonic currents according to some embodiments of the present disclosure.

### DETAILED DESCRIPTION

To provide a clearer understanding of the technical solutions of the embodiments described in the present disclosure, a brief introduction to the drawings required for the description of the embodiments will be provided below. The drawings do not represent all embodiments.

It should be understood that the terms “system,” device,” “unit,” and/or “module” used herein are a way for distinguishing different components, elements, parts, sections, or assemblies at different levels. If other words can achieve the same purpose, they may be replaced with other expressions.

As shown in the present disclosure and the claims, unless context clearly indicates otherwise, terms such as “one,” “an,” “a,” and/or “the” are not specific to singular and may also include plural. Generally, the terms “comprise,” “comprises,” “comprising” and “include,” “includes,” “including” merely indicate the inclusion of specifically identified operations and elements, and these operations and elements do not constitute an exclusive list, as methods or devices may also include other operations or elements.

When processes described as being performed in operations in the embodiments of the present disclosure are executed, unless otherwise specified, the order of the operations is interchangeable, operations may be omitted, and additional operation or operations may be included in the processes.

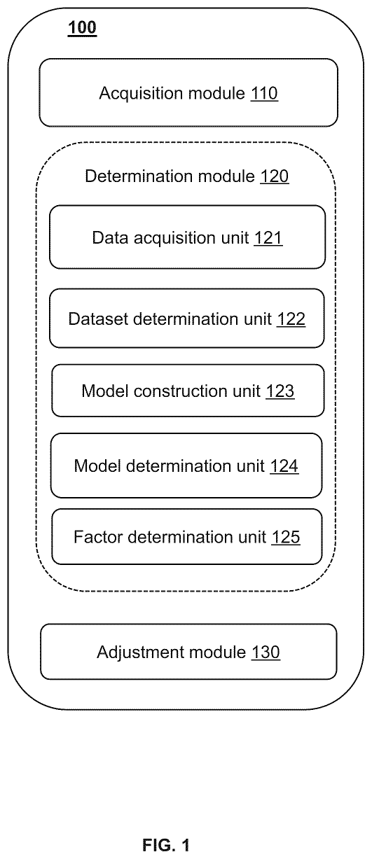

FIG. 1 is schematic diagram of exemplary modules of a system for monitoring and adjusting a harmonic emission level of an industrial load according to some embodiments of the present disclosure.

In some embodiments, a system 100 for monitoring and adjusting a harmonic emission level of an industrial load may include an acquisition module 110, a determination module 120, and an adjustment module 130.

In some embodiments, the system 100 for monitoring and adjusting the harmonic emission level of the industrial load may include a processor. The processor may be configured to process data related to the system 100. The acquisition module 110, the determination module 120, and the adjustment module 130 may be configured as processors.

In some embodiments, the processor may be a single server or a server group. The server group may be centralized or distributed. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an on-premises cloud, a multi-tiered cloud, etc. or any combination thereof.

The acquisition module 110 is a module configured to acquire a grid load.

In some embodiments, the acquisition module 110 may be configured to obtain a grid load for a current time period based on a power monitoring device deployed in a target region. At least one type of industrial load is operating in the target region.

The determination module 120 is a module configured to determine a generalized probabilistic model of the industrial load.

In some embodiments, the determination module 120 may be configured to determining, for each of the at least one type of industrial load, a generalized probabilistic model for the industrial load.

In some embodiments, the determination module 120 may include a data acquisition unit 121, a dataset determination unit 122, a model construction unit 123, a model determination unit 124, and a factor determination unit 125.

The data acquisition unit 121 is a unit for obtaining harmonic monitoring data.

In some embodiments, the data acquisition unit 121 may be configured to obtain, based on a power quality monitoring device deployed at at least one preset location around the industrial load, harmonic monitoring data of the industrial load at a preset frequency, wherein the at least one preset location includes a wire coupling position of the industrial load and the preset frequency is determined based on the grid load at the current time period.

The dataset determination unit 122 is the unit for determining the harmonic characteristic dataset for the industrial load.

In some embodiments, the dataset determination unit 122 may be configured to determine, based on the harmonic monitoring data, a harmonic characteristic dataset for the industrial load, the harmonic characteristic dataset including at least one piece of target harmonic data.

In some embodiments, the dataset determination unit 122 may be configured to construct the harmonic characteristic dataset by extracting the harmonic monitoring data of the industrial load, the harmonic characteristic dataset being represented as:

$$X = [ \begin{matrix}{I}_{2}^{1} & {I}_{3}^{1} & … & {I}_{25}^{1} \\ {I}_{2}^{2} & {I}_{3}^{2} & … & {I}_{25}^{2} \\ ⋮ & ⋮ & ⋮ & ⋮ \\ {I}_{2}^{N} & {I}_{3}^{N} & … & {I}_{25}^{N}\end{matrix} ]$$

Where N represents a total count of sampling points, each column vector in X represents a harmonic current monitoring sequence of an order, I represents the harmonic current, the subscript of I represents a harmonic order, and the superscript of I represents a sampling sequence number.

The model construction unit 123 refers to a unit configured to construct an initial generalized probabilistic model.

In some embodiments, the model construction unit 123 may construct the initial generalized probabilistic model for the target harmonic data.

In some embodiments, the model construction unit 123 may construct an initial generalized probabilistic model ƒ(Iₕ) for the target harmonic data in the harmonic characteristic dataset:

$$f ( {I}_{h} ) = {\sum }_{i = 1}^{3} {λ}_{i} {f}_{i} ( {I}_{h} )$$

Wherein, ƒᵢ(·) represents a sub-probability density function, λᵢ represents a weight coefficient of the sub-probability density function, Iₕ represents an h-th harmonic current, the initial generalized probabilistic model is a linear combination of three sub-probability density functions, ƒ₁(·) represents a portion of Iₕ obeying a normal distribution, ƒ₂(·) represents a portion of Iₕ obeying a lognormal distribution, ƒ₃(·) represents a portion of Iₕ obeying another distribution, and ƒᵢ(·) is represented as:

$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} \\ {f}_{2} ( {I}_{h} ) = \frac{1}{\sqrt{2 π} {I}_{h} {σ}_{2}} {e}^{- \frac{{( {lnI}_{h} - {μ}_{2} )}^{2}}{2 {σ}_{2}^{2}}} \\ {f}_{3} ( {I}_{h} ) = \frac{1}{nb} {\sum }_{j = 1}^{n} K ( \frac{{I}_{h} - {I}_{h}^{j}}{b} )$$

Wherein μ₁ and μ₂ represent mathematical expectations of the sub-probability density function, σ₁ and σ₂ represent standard deviations of the sub-probability density function, K(·) represents a kernel function, b>0, b represents a smoothing parameter referred to as a bandwidth or a window, Iₕ^{j} represents a j-th sample of Iₕ in each window, and n represents a total count of samples in each window, and the weight coefficient of the sub-probability density function satisfies the following equation:

$${\sum }_{i = 1}^{3} {λ}_{i} = 1 ( 0 \leq {λ}_{i} \leq 1 )$$

wherein λ₁=1 or λ₁=2, indicating that Iₕ obeys a single normal distribution or a lognormal distribution.

The model determination unit 124 refers to a unit configured to determine the generalized probabilistic model.

In some embodiments, the model determination unit 124 may obtain the generalized probabilistic model for the target harmonic data by optimizing a parameter of the initial generalized probabilistic model.

In some embodiments, the model determination unit 124 may discretize the initial generalized probabilistic model to obtain a discretized initial generalized probabilistic model ƒ(Ĩₕ):

$$f ( {\tilde{I}}_{h} ) = {\sum }_{i = 1}^{3} {λ}_{i} {f}_{i} ( {\tilde{I}}_{h} ) , {\tilde{I}}_{h} = 0 : 0.1 : max ( {I}_{h} )$$

Wherein max(Iₕ) represents a maximum value of an h-th harmonic current, and Ĩₕ represents a discretized h-th harmonic current.

In some embodiments, the model determination unit 124 may construct a parameter optimization model for the discretized initial generalized probabilistic model through operations including: constructing objective functions min y₁, min y₂, and min y:

$$min {y}_{1} = {( {\sum }_{i = 1}^{3} {λ}_{i} {E}_{i} ( {\tilde{I}}_{h} ) - {E}_{0} ( {\tilde{I}}_{h} ) )}^{2} \\ min {y}_{2} = {( \sqrt{{\sum }_{i = 1}^{3} {λ}_{i}^{2} {Var}_{i} ( {\tilde{I}}_{h} )} - \sqrt{{Var}_{0} ( {\tilde{I}}_{h} )} )}^{2}$$

Wherein y₁ and y₂ represent mean square errors of an mathematical expectation and a standard deviation of the discretized initial generalized probabilistic model, respectively; Eᵢ(Ĩₕ) and E₀(Ĩₕ) represent a mathematical expectation of Ĩₕ computed from a sub-probability density function and an actual mathematical expectation of Ĩₕ, respectively; Varᵢ(Ĩₕ) and Var₀(Ĩₕ) represent a standard deviation of Ĩₕ computed from the sub-probability density function and an actual standard deviation of Ĩₕ, respectively.

In some embodiments, the model determination unit 124 may combine the objective functions min y₁ and miny₂ into a single minimized objective function, the combined minimized objective function may be represented as:

$$min y = \frac{{y}_{1} + {y}_{2}}{2}$$

In some embodiments, the model determination unit 124 may determine constraints, wherein the constraints include an equality constraint l and an inequality constraint g_{q}. The equality constraint l=Σᵢ₌₁³λᵢ−1=0 is used for optimizing a weight coefficient λᵢ of the probability density function, the inequality constraint g_{q} may include a value range of the weight coefficient λᵢ and a value range of a random variable Ĩₕ determined by a numerical characteristic (μ₁, σ₁), (μ₂, σ₂) of the random variable Ĩₕ under an action of a single sub-probability density function. For example, the inequality constraint for λᵢ may be represented as:

$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix}$$

Exemplarily, assuming the 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈], and the inequality constraint for optimality-seeking variables {μ₁, μ₂, σ₁, σ₂} may be represented as:

$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix}$$

$$\{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix}$$

$$\{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix}$$

$$\{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix}$$

Wherein g_{q} represents the inequality constraint and q=1, 2, . . . , 11.

In some embodiments, the model determination unit 124 may be further configured to obtain the generalized probabilistic model for the target harmonic data by optimizing the parameter of the initial generalized probabilistic model and determining a parameter of the generalized probabilistic model through operations including: transforming the constrained problem into an unconstrained problem, using a multiplier technique to solve the unconstrained problem by setting a set of optimization-seeking variables to be γ={λ₁, λ₂, λ₃, μ₁, μ₂, σ₁, σ₂} and defining an augmented Lagrangian function as J, the augmented Lagrangian function J may be represented as:

$$J ( γ , ω , v , ρ ) = y ( γ ) - vl ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \}$$

Wherein y(γ) represents the objective function, l(γ) represents the equality constraint, g(γ) represents the inequality constraint, ω_{g} represents a Lagrange multiplier of an inequality constraint part, and ν represents a Lagrange multiplier of an equality constraint part, ρ represents a penalty parameter.

In some embodiments, for J(γ, ω, ν, ρ), the model determination unit 124 may take a sufficient large penalty parameter ρ and obtain a locally optimal solution by minimizing J(γ, ω, ν, ρ) through iterative correction of the multipliers ω and ν, where a correction equation for the multipliers ω and ν may be represented as:

$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix}$$

Wherein the superscript k represents a count of corrections.

In some embodiments, the objective function may be determined through the following equation:

$${E}_{1} ( {\tilde{I}}_{h} ) = {μ}_{1} , {Var}_{1} ( {\tilde{I}}_{h} ) = {σ}_{1}^{2}$$

$${E}_{2} ( {\tilde{I}}_{h} ) = {e}^{{μ}_{2} + {σ}_{2}^{2} / 2} , {Var}_{2} ( {\tilde{I}}_{h} ) = ( {e}^{{σ}_{2}^{2}} - 1 ) {e}^{2 {μ}_{2} + {σ}_{2}^{2}}$$

$${E}_{3} ( {\tilde{I}}_{h} ) = {\sum }_{j = 1}^{{N}_{1}} {\tilde{I}}_{h}^{j} p ( {\tilde{I}}_{h}^{j} )$$

$${Var}_{3} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} )$$

$${N}_{1} = length ( {\tilde{I}}_{h} )$$

$$p ( {\tilde{I}}_{h}^{j} ) = \frac{{f}_{3} ( {\tilde{I}}_{h}^{j} )}{sum ( {f}_{3} ( {\tilde{I}}_{h}^{j} ) )}$$

Where length(Ĩₕ) represents a length of Ĩₕ, p(Ĩₕ) represents a probability of Ĩₕ obeying another distribution, and p(Ĩₕ^{j}) represents a probability of Ĩₕ^{j} obeying another distribution.

The factor determination unit 125 is a unit configured to determine a harmonic impact factor of an industrial load.

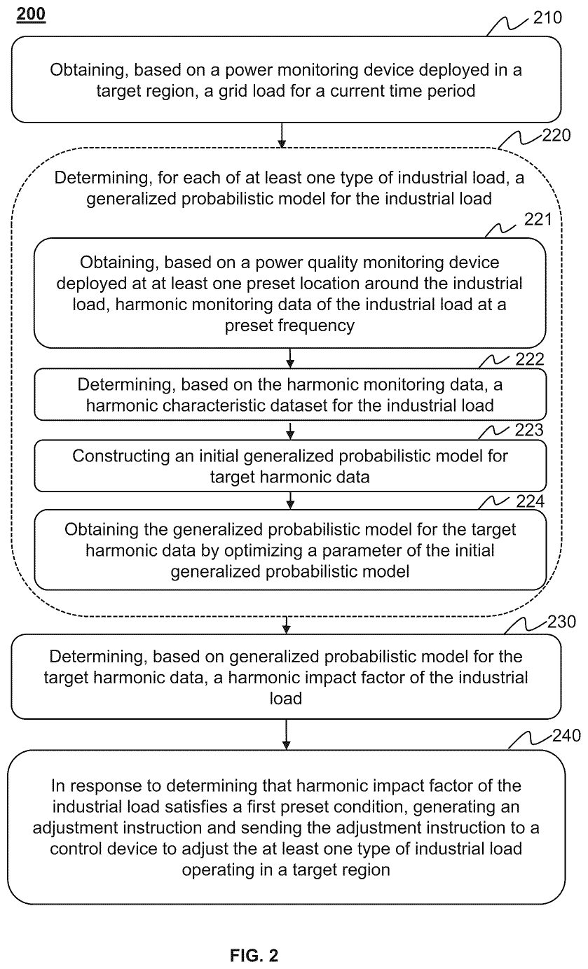

In some embodiments, the determination factor unit 125 may determine, based on the generalized probabilistic model for the target harmonic data, a harmonic impact factor of the industrial load. More descriptions of the harmonic impact factor may be found in FIG. 2 and the related descriptions thereof.

The adjustment module 130 refers to a module configured to make adjustments to the industrial load operating in the target region.

In some embodiments, in response to determining that the harmonic impact factor of the industrial load satisfies a first preset condition, the adjustment module 130 may be configured to: generate an adjustment instruction and send the adjustment instruction to a control device to adjust the at least one type of industrial load operating in the target region, wherein the adjustment instruction includes a first adjustment instruction configured to control a target industrial load to reduce a count of electricity consumption devices and a second adjustment instruction configured to cut off a power supply of the target industrial load. More descriptions of adjusting the industrial load may be found in FIG. 2 and the related descriptions thereof.

More descriptions of the acquisition module 110, the determination module 120, and the adjustment module 130 may be found in the relevant descriptions of FIG. 2-FIG. 5.

It is to be noted that the above descriptions of the system 100 for monitoring and adjusting the harmonic emission level of the industrial load and the modules thereof are provided only for the convenience of the description, and it is not to be taken as limiting the present disclosure to the scope of the embodiments cited. It is to be understood that for a person skilled in the art, after understanding the principle of the system, it may be possible to arbitrarily combine two or more modules or form a sub-system to be connected to the other modules without departing from the principle. In some embodiments, the acquisition module 110, the determination module 120, and the adjustment module 130 disclosed in FIG. 1 may be different modules in a single system, or a single module realizing the functions of two or more modules. For example, the modules may share a common storage module, and each module may have its own storage module. Deformations such as these are within the scope of protection of the present disclosure.

FIG. 2 is a flowchart of an exemplary process of a method for monitoring and adjusting a harmonic emission level of an industrial load according to some embodiments of the present disclosure. In some embodiments, a process 200 may be executed by a processor. The process 200 may include the following operations as shown in FIG. 2.

In 210, a grid load for a current time period may be obtained based on a power monitoring device deployed in a target region.

The target region refers to a region of a grid where the industrial load is located. In some embodiments, at least one type of industrial load operates in the target region. The industrial load refers to an electrical system that includes electricity consumption devices, for example, a steel mill, a power plant, or the like.

In some embodiments, the processor may classify the type of the industrial load based on a function of the industrial load. For example, the type of the industrial load may include a steel industrial load, a chemical industrial load, or the like.

In some embodiments, a power monitoring device is deployed in the target region.

The power monitoring device is a device configured to monitor power. For example, power monitoring device may include an electric meter, a power tester, or the like.

The current time period refers to a period of time before a current moment. For example, the past 15 minutes of the current moment. The duration of the current time period may be preset by a technician or by system default.

The grid load refers to a load profile of an electrical parameter in the target region. For example, the grid load may be represented by electricity consumption, and the grid load for the current time period may be represented by a sum of the electricity consumption for the current time period.

In some embodiments, the grid load may be used to assess a risk level of the grid within the target region. For example, the greater the grid load within the target region, the greater the risk of a grid failure within the target region, and the greater a ripple effect of the grid failure. In some embodiments, the processor may obtain the grid load for the current time period in various ways based on the power monitoring device. In some embodiments, the processor may obtain the electricity consumption for the current time period (e.g., an electricity consumption of 50 KW in the last 15 minutes) by reading the power monitoring device (e.g., a meter 1). In some embodiments, the processor may determine a sum of the electricity consumption of all power monitoring devices in the target region in the current time period as the grid load for the current time period. For example, the target region has a meter 1, a meter 2, and a meter 3, and the processor reads the meter 1, the meter 2, and the meter 3 to obtain the power consumption in the past 15 minutes as 50 KW, 40 KW, and 60 KW, respectively, and then the grid load in the past 15 minutes is 150 KW.

In 220, for each of the at least one type of industrial load, a generalized probabilistic model for the industrial load may be determined.

The generalized probabilistic model refers to a model used to determine an extent to which the industrial load affects the target region. In some embodiments, the generalized probabilistic model may be a probabilistic statistical model, for example, a probability density distribution function.

In some embodiments, operation 220 may include sub-operations 221-223.

In 221, harmonic monitoring data of the industrial load may be obtained at a preset frequency based on the power quality monitoring device deployed at at least one preset location around the industrial load.

The harmonic monitoring data is parameter data related to power quality. For example, harmonic monitoring data may include a fundamental voltage, an active power, a reactive power, an apparent power, a total harmonic voltage distortion rate, a total harmonic current distortion rate, a statistic of a harmonic ratio of a 2nd to 25th harmonic voltage, and a statistic of effective values of a 2nd to 25th harmonic current, or the like.

The harmonic current refers to a periodic non-sinusoidal shaped current signal (voltage signal) generated in an AC circuit.

The fundamental wave refers to a sinusoidal component of a periodic oscillation that is equal to a longest period of the oscillation. The fundamental wave voltage (fundamental wave current) is the effective value of the voltage (current) of the fundamental wave.

The active power refers to the amount of AC energy actually emitted or consumed per unit of time. The apparent power refers to a product of the effective values of voltage and current.

The total harmonic voltage distortion rate (total harmonic current distortion rate) refers to a sum of the percentage of the root of the square of the effective value of each harmonic voltage (current) to the effective value of the fundamental voltage (current).

The statistic of the harmonic ratio of the 2nd to 25th harmonic voltage (the statistic of the effective values of the 2nd to 25th harmonic current) refers to the statistical value of the ratio of the root mean square (RMS) value of the 2nd to 25th harmonic voltage (harmonic current) to the RMS value of the fundamental voltage (fundamental current) in periodic alternating current, expressed as a percentage.

In some embodiments, the processor may obtain the harmonic monitoring data at the preset frequency based on the power quality monitoring device.

The power quality monitoring device refers to a device configured to obtain the harmonic monitoring data. In some embodiments, the power quality monitoring device may be deployed at at least one preset location around the industrial load.

The preset location refers to a location set in advance for deploying the power quality monitoring device. The preset location may be located around the industrial load, and the exact location may be determined in advance by a technician based on experience or historical data. In some embodiments, the at least one preset location may include a wire coupling position of the industrial load.

The wire coupling position refers to a part of a wire where a busbar is coupled and connected to an incoming wire.

The preset frequency refers to a frequency set in advance for obtaining the harmonic monitoring data. For example, the preset frequency may be 3 min/time. In some embodiments, the preset frequency may be determined based on the grid load during the current time period. For example, the preset frequency may be negatively correlated with the grid load of the current time period. The greater the grid load in the target region during the current time period, the greater the risk of a grid failure, and the greater a range of impact caused by the grid failure, and thus the higher the preset frequency of the power quality monitoring device may be set in order to collect more harmonic monitoring data and realize a closer monitoring of the harmonic situation of the industrial load.

In 222, a harmonic characteristic dataset for the industrial load may be determined based on the harmonic monitoring data.

The harmonic characteristic dataset refers to a collection of data divided according to characteristics of the harmonic monitoring data, for example, a collection of harmonic currents or harmonic voltages. In some embodiments, the harmonic characteristic dataset may include at least one target harmonic data.

The target harmonic data refers to data specified for analysis in the harmonic monitoring data of the target region, for example, parameter data such as the harmonic current, the harmonic voltage, etc., of the target region.

In some embodiments, the processor may determine the harmonic characteristic dataset based on the harmonic monitoring data in various ways. For example, the processor may divide data of a same type (e.g., voltage data in the harmonic monitoring data) in the harmonic monitoring data into a same set, and sort and process the harmonic monitoring data in the set according to a preset rule to obtain the harmonic characteristic dataset. The preset rule may be determined based on empirical experience. For example, the preset rule may be to sort the harmonic monitoring data in chronological order.

In some embodiments, the target harmonic data may be the harmonic current, and the processor may extract the harmonic monitoring data of the industrial load to construct the harmonic characteristic dataset X, which may be represented by equation (1):

$$Harmonic characteristic dataset X = [ \begin{matrix}{I}_{2}^{1} & {I}_{3}^{1} & … & {I}_{25}^{1} \\ {I}_{2}^{2} & {I}_{3}^{2} & … & {I}_{25}^{2} \\ ⋮ & ⋮ & ⋮ & ⋮ \\ {I}_{2}^{N} & {I}_{3}^{N} & … & {I}_{25}^{N}\end{matrix} ] \qquad ( 1 )$$

Wherein N represents a total count of sampling points, each column vector in X represents a harmonic current monitoring sequence of an order, I represents the harmonic current, the subscript of I represents a harmonic order, and the superscript of I represents a sampling sequence number.

The total count of sampling points N represents the count of sampling points in total, which reflects a frequency of collecting the harmonic monitoring data. For example, N may be 300, 400, 500, etc., with a larger value of N indicating a higher frequency of collecting the harmonic monitoring data. A sampling point refers to a timestamp corresponding to a harmonic current. For example, different harmonic currents obtained at a same sampling point may be different harmonic currents obtained at a same time.

In some embodiments, the total count of sampling points N may be determined based on at least one of an average value of historical harmonic currents, a historical first stable sequence, and a historical second stable sequence during a historical time period.

The historical time period refers to a past period before a current time period. The historical time period precedes the current time period. For example, if the current time period is the past 15 minutes of a current time point, the historical time period may be from the past 60 minutes to the past 15 minutes of the current time point. The duration of the historical time period may be preset by a technician or by system default.

The average value of historical harmonic currents refers to the average value of the harmonic currents in historical data, which may reflect an extent of occurrence of the harmonic current over a period of time.

The historical first stable sequence refers to a sequence of historical data consisting of first standard deviations corresponding to different sampling points, which may reflect a degree of stability of the harmonic currents collected at different sampling points. The first standard deviation refers to the standard deviation of different harmonic currents at the same sampling point.

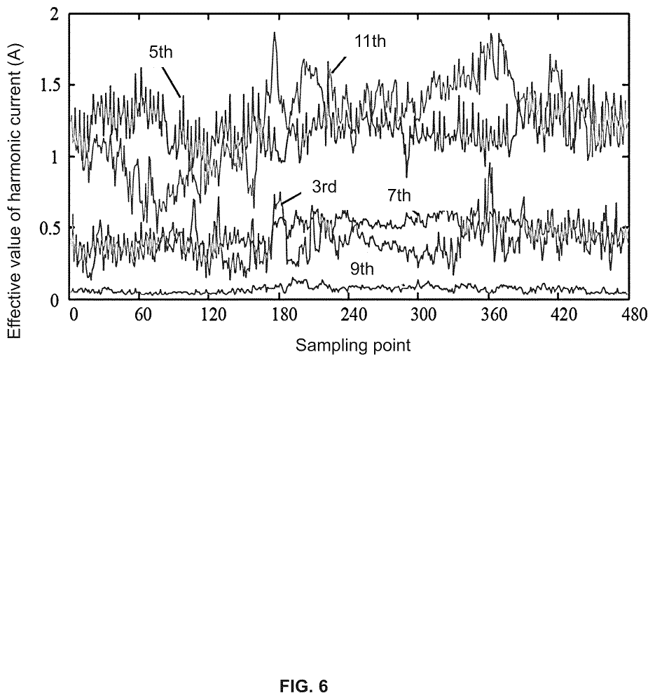

FIG. 6 is a graph of measured data of harmonic currents according to some embodiments of the present disclosure. The horizontal axis represents sampling points, and the vertical axis represents effective values of harmonic currents. The five broken lines represent the effective values of a 3rd harmonic current, a 5th harmonic current, a 7th harmonic current, a 9th harmonic current, and a 11th harmonic current at sampling point 1 to sampling point 480.

Taking the harmonic monitoring data in FIG. 6 as an example, there are 480 sampling points in the historical time period. The first standard deviation of the 3rd harmonic current, the 5th harmonic current, . . . , the 11th harmonic current at the sampling point 1 may be denoted as A₁, the first standard deviation of the 3rd harmonic current, the 5th harmonic current, . . . , the 11th harmonic current at the sampling point 2 may be denoted as A₂, and so on until the first standard deviation of the 3rd harmonic current, the 5th harmonic current, . . . , the 11th harmonic current at the sampling point 480 may be denoted as A₄₈₀. Thus, the historical first stable sequence may be represented as {A₁, A₂, . . . , A₄₈₀}.

The historical second stable sequence refers to a sequence of historical data consisting of second standard deviations corresponding to different sampling points, which may reflect a degree of stability of the harmonic currents collected at different sampling points. The second standard deviation refers to the standard deviation of the same harmonic current at different sampling points.

Taking the harmonic monitoring data in FIG. 6 as an example, there are 480 sampling points in the historical time period. The second standard deviation of the 3rd harmonic current at sampling points 1, 2, . . . , 480 may be denoted as B₃, the second standard deviation of the 5th harmonic current at sampling points 1, 2, . . . , 480 may be denoted as B₅, and so on until the second standard deviation of the 11th harmonic current at sampling points 1, 2, . . . , 480 may be denoted as B₁₁. Therefore, the historical second stable sequence may be represented as {B₃, B₅, B₇, B₉, B₁₁}.

In some embodiments, the processor may determine the total count of sampling points based on at least one of the average value of historical harmonic currents, the historical first stable sequence, and the historical second stable sequence during a historical time period by referring to a first preset relationship table. The first preset relationship table may include a first correspondence between the total count of sampling points and the average value of historical harmonic currents, the historical first stable sequence, and the historical second stable sequence.

The first correspondence may include that the total count of sampling points is positively correlated with the average value of historical harmonic currents, the historical first stable sequence, and the historical second stable sequence. If the value of the historical first stable sequence is larger, it represents that the current is more unstable, and the degree of harmonic occurrence is larger, thus requiring to obtain more harmonic monitoring data to be analyzed. Therefore, the processor may adjust the total count of sampling points based on the historical first stable sequence. The larger the value corresponding to the historical first stable sequence, the larger the total count of sampling points.

In some embodiments of the present disclosure, determining the total count of sampling points N based on the average value of historical harmonic currents, the historical first stable sequence, and the historical second stable sequence during a historical time period can make the determined total count of sampling points N more aligned with the degree of harmonic occurrence in the target region, thus making the obtained harmonic characteristic dataset more reliable.

In some embodiments, the harmonic order, represented as h, may be determined based on at least one of the average value of historical harmonic currents, the historical first stable sequence, and the historical second stable sequence during a historical time period.

In some embodiments, the processor may determine the harmonic order h based on at least one of the average value of historical harmonic currents, the historical first stable sequence, and the historical second stable sequence during the historical time period by referring to a second preset relationship table. The second preset relationship table may include a second correspondence between the harmonic order harmonics h and the average value of historical harmonic currents, the historical first stable sequence, and the historical second stable sequence.

The second correspondence may include that the harmonic order h is positively correlated with the average value of historical harmonic currents, the historical first stable sequence, and the historical second stable sequence. If the value of the historical first stable sequence is larger, it reflects greater harmonic instability, and thus requiring more harmonic monitoring data for analysis. Moreover, the higher a harmonic frequency, the larger the corresponding harmonic order, thus the processor may increase the harmonic order h correspondingly.

In some embodiments of the present disclosure, the harmonic order h is determined based on at least one of the average value of historical harmonic currents value, the historical first stable sequence, and the historical second stable sequence during the historical time period, and the harmonic order may be adjusted based on the historical data situation, thereby making the subsequently obtained generalized probabilistic model more accurate.

The harmonic current monitoring sequence refers to a sequence consisting of N harmonic currents with the same harmonic order collected at the total count of sampling points N. For example, the first column vector in the harmonic characteristic dataset X is a sequence consisting of N 2nd harmonic currents collected at N sampling point.

The harmonic order refers to a ratio of a harmonic frequency to a fundamental frequency. For example, the 2nd harmonic represents a harmonic frequency that is twice of the fundamental frequency.

The sampling sequence number refers to the sequence number of sampling points. For example, a sampling sequence number of 1 means that the processor is collecting data at a first sampling point.

In some embodiments, the processor may extract, from the harmonic monitoring data of the industrial load, each harmonic current at each sampling point, with the harmonic current monitoring sequence as a column vector and vectors consisting of 2nd to 25th harmonic currents collected at a same sampling point as a row vector, thereby constructing the harmonic characteristic dataset X.

In some embodiments of the present disclosure, by extracting the harmonic monitoring data from the industrial load and constructing the harmonic characteristic dataset X, the data in the harmonic monitoring data can be regularized into an intuitive form, facilitating subsequent analysis, and enabling a more efficient construction of an initial generalized probabilistic model.

In 223, an initial generalized probabilistic model for the target harmonic data may be constructed.

The initial generalized probabilistic model refers to a generalized probabilistic model initially constructed for analyzing the target harmonic data. In some embodiments, the initial generalized probabilistic model may be a probability density function, for example, a normal distribution function, a lognormal distribution function, or the like.

In some embodiments, the processor may construct the initial generalized probabilistic model for the target harmonic data in various ways. For example, the processor may predictively select a suitable probability density function based on a distribution form of the target harmonic data and determine the probability density function as the initial generalized probabilistic model.

In some embodiments, the processor may construct an initial generalized probabilistic model ƒ(Iₕ) for the target harmonic data in the harmonic characteristic dataset, as represented in equation (2).

$$f ( {I}_{h} ) = {\sum }_{i = 1}^{3} {λ}_{i} {f}_{i} ( {I}_{h} ) \qquad ( 2 )$$

Wherein ƒᵢ(·) represents a sub-probability density function, λᵢ represents a weight coefficient of the sub-probability density function, Iₕ represents an h-th harmonic current, the initial generalized probabilistic model is a linear combination of three sub-probability density functions, ƒ₁(·) represents a portion of Iₕ obeying a normal distribution, ƒ₂(·) represents a portion of Iₕ obeying a lognormal distribution, ƒ₃(·) represents a portion of Iₕ obeying another distribution. The another distribution may include a discrete distribution (e.g., a Poisson distribution, a binomial distribution, or the like) or other types of distributions.

The sub-probability density function ƒᵢ(·) represents sub-functions of the probability density function that obey different functional distributions.

In some embodiments, the processor may determine the sub-probability density function ƒᵢ(·) using equations (3)-(5):

$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} \qquad ( 3 )$$

$${f}_{2} ( {I}_{h} ) = \frac{1}{\sqrt{2 π} {I}_{h} {σ}_{2}} {e}^{- \frac{{( ln {I}_{h} - {μ}_{2} )}^{2}}{2 {σ}_{2}^{2}}} \qquad ( 4 )$$

$${f}_{3} ( {I}_{h} ) = \frac{1}{nb} {\sum }_{j = 1}^{n} K ( \frac{{I}_{h} - {I}_{h}^{j}}{b} ) \qquad ( 5 )$$

Wherein μ₁ and μ₂ represent mathematical expectations of the sub-probability density function, σ₁ and σ₂ represent standard deviations of the sub-probability density function, K(·) represents a kernel function, b>0, b represents a smoothing parameter referred to as a bandwidth or a window, Iₕ^{j} represents a j-th sample of Iₕ in each window, and n represents a total count of samples in each window.

The kernel function K(·) is an inner product of mapping relations, which may map nonlinear transformations from an input space to a higher dimensional space. For example, the kernel function K(·) may include a linear kernel function, a polynomial kernel function, a Gaussian kernel function, or the like.

The smoothing parameter b is a coefficient of the kernel function, also referred to as the bandwidth or window. The smoothing parameter may be used to control a smoothness degree and a sensitivity degree of the kernel function. For example, a range of values for the smoothing parameter b may be [0,1]. The larger the value of the smoothing parameter b, the wider an influence range of the kernel function, and the higher the smoothness degree of the model; conversely, the smaller the value of the smoothing parameter b, the narrower the influence range of the kernel function, and the higher the complexity of the model. In some embodiments, each window includes corresponding samples, respectively, where the total count of samples may be determined based on a size of the window.

In some embodiments, the processor may determine the weight coefficient λᵢ for the sub-probability density function by using an equation (6):

$${\sum }_{i = 1}^{3} {λ}_{i} = 1 ( 0 \leq {λ}_{i} \leq 1 ) \qquad ( 6 )$$

wherein λ₁=1 or λ₁=2, indicating that Iₕ obeys a single normal distribution or a lognormal distribution.

In some embodiments of the present disclosure, constructing the initial generalized probabilistic model by determining the sub-probability density function and the corresponding weight can more accurately restore a characteristic of the target harmonic data in the harmonic characteristic dataset, making the obtained initial generalized probabilistic model more accurate.

In 224, the generalized probabilistic model for the target harmonic data may be obtained by optimizing a parameter of the initial generalized probabilistic model.

The generalized probabilistic model is a model obtained by optimizing the parameter of the initial generalized probabilistic model. In some embodiments, the generalized probabilistic model may be a probability density function, for example, a normal distribution function, a lognormal distribution function, or the like.

In some embodiments, the processor may optimize and solve the parameter of the initial generalized probabilistic model in a variety of ways to obtain the generalized probabilistic model.

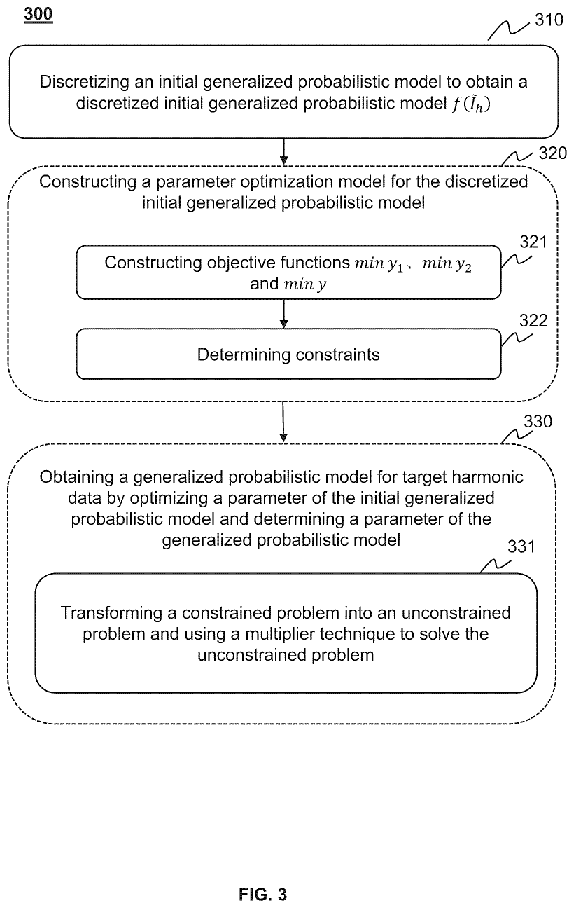

In some embodiments, the processor may optimize the parameter of the initial generalized probabilistic model through discretization or the like to determine a parameter of the generalized probabilistic model, thus obtaining the generalized probabilistic model for the target harmonic data. More descriptions on obtaining the generalized probabilistic model for the target harmonic data may be found in FIG. 3 and the related descriptions thereof.

In 230, a harmonic impact factor of the industrial load may be determined based on the generalized probabilistic model for the target harmonic data.

The harmonic impact factor refers to a degree to which the target harmonic data generated by a single industrial load affects the safe operation of the power grid within the target region. In some embodiments, the harmonic impact factor may be represented by a numerical value. The larger the numerical value, the larger the harmonic impact factor, and the greater the degree to which the target harmonic data affects the safe operation of the power grid. Each industrial load has a corresponding harmonic impact factor.

In some embodiments, the processor may determine the harmonic impact factor of the industrial load based on the model parameter of the generalized probabilistic model for the target harmonic data via a third preset relationship table.

The third preset relationship table may include a third correspondence between the model parameters {λ₁, λ₂, μ₁, μ₂, σ₁, σ₂} of the generalized probabilistic model and the harmonic impact factor. The third correspondence may be obtained by a technician based on historical data or historical experience.

In 240, in response to determining that the harmonic impact factor of the industrial load satisfies a first preset condition, an adjustment instruction may be generated and sent to a control device to adjust the at least one type of industrial load operating in the target region.

The first preset condition refers to a condition set in advance for determining whether an impact of the target harmonic data on safe operation is out of range. The first preset condition may be pre-set by a technician or by system default. For example, the first preset condition may be that a comprehensive harmonic impact factor is greater than a preset threshold.

The comprehensive harmonic impact factor refers to a total degree of impact on the safe operation of the power grid of the target harmonic data generated by all industrial loads in the target region. In some embodiments, the processor may obtain the comprehensive harmonic impact factor by performing a weighted sum on the harmonic impact factor of each industrial load.

Weights and the preset threshold for the weighted sum may be set in advance by a technician based on experience or by system default.

A target industrial load refers to an industrial load that needs to be adjusted. In some embodiments, the processor may rank the harmonic impact factors of industrial loads from high to low, and select a predefined number (e.g., the top 3) of the industrial loads with high rankings as target industrial loads.

The adjustment instruction refers to an instruction for making an adjustment to the target industrial load in the target region. In some embodiments, the adjustment instruction may include a first adjustment instruction and a second adjustment instruction.

The first adjustment instruction may be configured to control the target industrial load to reduce a count of electricity consumption devices. An electricity consumption device is a device that consumes electricity from a power system to generate electrical power, for example, an electric boiler, a fan, a smelting furnace in a factory, or the like.

In some embodiments, the processor may determine a target electricity consumption value of the target industrial load based on the harmonic impact factor of the target industrial load via a fourth preset relationship table.

The target electricity consumption value refers to an upper limit of the amount of electricity that may be consumed by the electricity consumption device under a safe operating condition, for example, 2000 kW, or a current limit of the electricity consumption device. In some embodiments, the power usage target value may be determined by looking up a correspondence between the harmonic impact factor and the target electricity consumption value of the target industrial load in the fourth preset relationship table.

The fourth predefined relationship table may include a fourth correspondence between the harmonic impact factor and the target electricity consumption value. The fourth correspondence may be obtained by a technician based on historical data or historical experience.

In some embodiments, in response to determining that harmonic impact factor of the industrial load satisfies the first preset condition, the processor may generate the first adjustment instruction to control the target industrial load to reduce the count of electricity consumption devices, so as to reduce the electricity consumption of the target industrial load to the electricity consumption target value.

The second adjustment instruction may be configured to cut off a power supply of the target industrial load. In some embodiments, in response to determining that harmonic impact factor of the industrial load satisfies the first preset condition, if controlling the target industrial load to reduce the count of electricity consumption devices is not able to ensure the safe operation of the power grid, the processor may generate the second adjustment instruction that may be configured to cut off the power supply of the target industrial load. Cutting off the power supply of the target industrial load refers to cutting off the power supply of the target industrial load after a preset time.

The preset time refers to an amount of time set aside for a user to make work adjustments. The duration of the preset time may be preset manually or by system default. For example, the preset time may be 20 minutes after the processor receives the second adjustment instruction.

The user refers to a technician associated with the use of the system 100 for monitoring and adjusting the harmonic emission level of the industrial load. For example, the user may include a safety administrator of the target region, a technician associated with analyzing harmonic demand, or the like.

In some embodiments of the present disclosure, by obtaining the harmonic monitoring data of the grid load and the industrial load in the current time period, determining the harmonic characteristic dataset, and constructing the initial generalized probabilistic model, an actual situation of the industrial load can be efficiently and accurately analyzed, thereby providing a solid data foundation for the accurate construction of the initial generalized probabilistic model. By determining the harmonic characteristic dataset based on historical data, the harmonic characteristic dataset obtained is more in line with an operating rule of the at least one type of industrial load in the target region, improving the accuracy and authenticity of the harmonic characteristic dataset. By optimizing the parameter of the initial generalized probability model to obtain the generalized probability model, determining the harmonic impact factor based on the generalized probability model, and controlling and adjusting the industrial load based on the harmonic impact factors, safety accidents caused by the industrial load exceeding a standard can be timely prevented. By configuring the first adjustment instruction, work can continue on the basis of ensuring safety in a production process. By configuring the second adjustment instruction, the user is provided with time to arrange an industrial production schedule based on the implementation of work, thereby preventing work accidents caused by sudden enforcement of a power adjustment.

FIG. 3 is a flowchart of an exemplary process of obtaining a generalized probabilistic model through parameter optimization of an initial generalized probabilistic model according to some embodiments of the present disclosure. As shown in FIG. 3, a process 300 may include operations 310-330 as described below. In some embodiments, the process 300 may be executed by a processor.

In 310, an initial generalized probabilistic model may be discretized to obtain a discretized initial generalized probabilistic model ƒ(Ĩₕ).

Since ƒ₁(·) and ƒ₂(·) are continuous functions and ƒ₃(·) is a discrete function, the two types of functions cannot be directly weighted and summed using equation (2), therefor it is necessary to discretize functions ƒ₁(·) and ƒ₂(·), i.e., to convert the functions ƒ₁(·) and ƒ₂(·) into discrete functions.

In some embodiments, the discretization of ƒ₁(·) and ƒ₂(·) may be achieved through the discretization of Iₕ. The discretization of Iₕ may be achieved using an equal-width technique, which divides a range of values of Iₕ (0, max(Iₕ)) by a certain step size (e.g., 0.01) to obtain a discretized Iₕ. The discretized Iₕ may be represented by the following equation (7):

$${\tilde{I}}_{h} = 0 : 0.01 : max ( {I}_{h} ) \qquad ( 7 )$$

Wherein max(Iₕ) denotes a maximum value of an h-th harmonic current, 0.01 denotes the step size, and Iₕ denotes a discretized h-th harmonic current.

In some embodiments, the processor may construct the discretized initial generalized probabilistic model based on the discretized h-th harmonic current. The discretized initial generalized probabilistic model ƒ(Ĩₕ) may be represented by an equation (8):

$$f ( {\tilde{I}}_{h} ) = {\sum }_{i = 1}^{3} {λ}_{i} {f}_{i} ( {\tilde{I}}_{h} ) \qquad ( 8 )$$

Wherein ƒᵢ(Ĩₕ) denotes the three sub-probability density functions of Ĩₕ and λᵢ denotes weigh coefficients of the sub-probability density functions.

In 320, a parameter optimization model for the discretized initial generalized probabilistic model may be constructed.

Equations (3) to (8) indicate that by adjusting values of the parameter set {λ₁, λ₂, λ₃, μ₁, μ₂, σ₁, σ₂, b}, the above discretized initial generalized probabilistic model is able to approximate a probability distribution function of any random variable. The smoothing parameter b may be set by a technician through experience, and the other parameters λ₁, λ₂, λ₃, μ₁, μ₂, σ₁, σ₂ may be solved by constructing the parameter optimization model.

The parameter optimization model refers to a model configured to optimize the parameter of the discretized initial generalized probabilistic model. In some embodiments, the parameter optimization model may be a mathematical model that seeks an optimal solution through mathematical modeling or an optimization technique. The parameter optimization model may include an objective function, a decision variable, a constraint, or the like.

In some embodiments, operation 320 may include sub-operations 321 and 322.

In 321, objective functions min y₁, min y₂, and min y may be constructed.

The objective functions refer to functions used to optimize the discretized initial generalized probabilistic model. The objective function may characterize a difference between a predicted result of the discretized initial generalized probabilistic model and an actual result. A degree of approximation of the discretized initial generalized probabilistic model to the actual probability distribution of Ĩₕ may be intuitively reflected by a difference between a mathematical expectation computed by the discretized initial generalized probabilistic model and an actual mathematical expectation, and a difference between a standard deviation computed by the discretized initial generalized probabilistic model and an actual standard deviation. The higher the accuracy of the discretized initial generalized probabilistic model, the smaller the difference. In some embodiments, the objective functions may be represented by the following equations (9) and (10):

$$min {y}_{1} = {( {\sum }_{i = 1}^{3} {λ}_{i} {E}_{i} ( {\tilde{I}}_{h} ) - {E}_{0} ( {\tilde{I}}_{h} ) )}^{2} \qquad ( 9 )$$

$$min {y}_{2} = ( \sqrt{{\sum }_{i = 1}^{3} {λ}_{i}^{2} {Var}_{i} ( {\tilde{I}}_{h} )} - \sqrt{{{Var}_{0} ( {\tilde{I}}_{h} ) )}^{2}} \qquad ( 10 )$$

Wherein y₁ and y₂ represent mean square errors of the mathematical expectation and the standard deviation of the discretized initial generalized probabilistic model, respectively; Eᵢ(Ĩₕ) and E₀(Ĩₕ) represent a mathematical expectation of Ĩₕ computed from a sub-probability density function and an actual mathematical expectation of Ĩₕ, respectively; Varᵢ(Ĩₕ) and Var₀(Ĩₕ) represent a standard deviation of Ĩₕ computed from the sub-probability density function and an actual standard deviation of Ĩₕ, respectively.

In some embodiments, in the above objective functions, the mathematical expectation and standard deviation are obtained by the discretized initial generalized probabilistic model based on equations (11) to (16):

$${E}_{1} ( {\tilde{I}}_{h} ) = {μ}_{1} , {Var}_{1} ( {\tilde{I}}_{h} ) = {σ}_{1}^{2} \qquad ( 11 )$$

$${E}_{2} ( {\tilde{I}}_{h} ) = {e}^{{μ}_{2} + \frac{{σ}_{2}^{2}}{2}} , {Var}_{2} ( {\tilde{I}}_{h} ) = ( {e}^{{σ}_{2}^{2}} - 1 ) {e}^{2 {μ}_{2} + {σ}_{2}^{2}} \qquad ( 12 )$$

$${E}_{3} ( {\tilde{I}}_{h} ) = {\sum }_{j = 1}^{{N}_{1}} {\tilde{I}}_{h}^{j} p ( {\tilde{I}}_{h}^{j} ) \qquad ( 13 )$$

$${Var}_{3} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} ) \qquad ( 14 )$$

$${N}_{1} = length ( {\tilde{I}}_{h} ) \qquad ( 15 )$$

$$p ( {\tilde{I}}_{h}^{j} ) = \frac{{f}_{3} ( {\tilde{I}}_{h}^{j} )}{sum ( {f}_{3} ( {\tilde{I}}_{h} ) )} \qquad ( 16 )$$

The equations (11)-(14) represent the mathematical expectation and standard deviation of Ĩₕ computed from the sub-probability density functions λ₁, λ₂, and λ₃, length(Ĩₕ) denotes a length of Ĩₕ, p(Ĩₕ) denotes a probability that Ĩₕ obeys another distribution, and p(Ĩₕ^{j}) denotes a probability that Ĩₕ^{j} obeys another distribution.

In some embodiments, the processor may combine the objective functions min y₁ and miny₂ into a single minimized objective function, which facilitates subsequent solution using an optimization technique for a single objective optimization problem. The minimized objective function may be represented by an equation (17):

$$min y = \frac{{y}_{1} + {y}_{2}}{2} \qquad ( 17 )$$

In 322, constraints may be determined.

The constraints refer to conditions used to limit the solution of an optimization problem. The constraints are used to limit the feasibility of a solution of a problem so that the solution meets a requirement of the actual problem.

In some embodiments, the constraints may include an equality constraint l and an inequality constraint g_{q}. The equality constraint l is used to optimize the weight coefficient λᵢ of the sub-probability density function, which may be represented by the following equation (18):

$$l = {\sum }_{i = 1}^{3} {λ}_{i} - 1 = 0 \qquad ( 18 )$$

An optimality-seeking variable refers to a decision variable that minimize the value of the objective function. In some embodiments, the optimality-seeking variable may include the weight coefficient λᵢ and a numerical characteristic (μ₁, σ₁), (μ₂, σ₂) of a random variable Ĩₕ, i.e., the optimality-seeking variable may include λ₁, λ₂, λ₃, μ₁, μ₂, σ₁, and σ₂.

Based on the optimality-seeking variables, the inequality constraint g_{q} may include two main categories: one category is a value range of the weight coefficient λᵢ and the other category is a value range of the random variable Ĩₕ determined by the numerical characteristic (μ₁, σ₁), (μ₂, σ₂) of the random variable Ĩₕ under an action of a single sub-probability density function.

The inequality constraint for the weight coefficient λᵢ may be represented by the following equation (19):

$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix} \qquad ( 19 )$$

In some embodiments, the processor may use a maximum likelihood estimation technique to evaluate the numerical characteristic of Ĩₕ obeying a single normal distribution or a lognormal distribution, and designate confidence upper and lower limits with a confidence level of 0.95 as the value range for {μ₁, μ₂, σ₁, σ₂}. Assuming the 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈], and the inequality constraint for the optimality-seeking variables {μ₁, μ₂, σ₁, σ₂} may be represented by equations (20)-(23):

$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix} \qquad ( 20 )$$

$$\{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix} \qquad ( 21 )$$

$$\{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix} \qquad ( 22 )$$

$$\{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix} \qquad ( 23 )$$

In the equations (19)-(23), g_{q} represents the inequality constraint and q=1, 2, . . . , 11.

In 330, the generalized probabilistic model for the target harmonic data may be obtained by optimizing the parameter of the initial generalized probabilistic model and determining a parameter of the generalized probabilistic model.

In some embodiments, the processor may determine an optimal solution that minimizes the objective function under a constraint using various techniques, for example, a Karush-Kuhn-Tucker (KKT) condition, a penalty function technique, an augmented Lagrange multiplier technique, etc.

Taking the augmented Lagrange multiplier technique as an example, operation 330 may include sub-operation 331.

In 331, a constrained problem may be transformed into an unconstrained problem and the unconstrained problem may be solved by using a multiplier technique.

An optimization problem with multiple equality constraints and inequality constraints may be transformed into an unconstrained problem. In order to transform the constraints into part of the objective function, multiple Lagrange multipliers may be introduced and an augmented Lagrangian function may be constructed. For any Lagrange multiplier, the augmented Lagrangian function may be regarded as an unconstrained optimization problem. Therefore, the original problem may be solved by minimizing the augmented Lagrangian function, i.e., obtaining the optimal solution of the optimality-seeking variables and the corresponding Lagrange multipliers.

In some embodiments, let the set of optimality-seeking variables be denoted as γ={λ₁, λ₂, λ₃, μ₁, μ₂, σ₁, σ₂}, and define the augmented Lagrangian function as J:

$$J ( γ , ω , v , ρ ) = y ( γ ) - vl ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \} \qquad ( 24 )$$

Wherein y(γ) represents the objective function, l(γ) represents the equality constraint, g_{q}(γ) represents the inequality constraint, ω_{q} represents a Lagrange multiplier of an inequality constraint part, and ν represents a Lagrange multiplier of an equality constraint part, ρ represents a penalty parameter.

For J(γ, ω, ν, ρ), a locally optimal solution may be obtained by taking a sufficiently large penalty parameter ρ and minimizing J(γ, ω, ν, ρ) through iterative correction of the multipliers ω and ν. The correction equation for the multipliers ω and ν may be represented by an equation (25):

$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix} \qquad ( 25 )$$

Wherein, the superscript k represents a count of corrections.

The count of corrections is the count of times the Lagrange multipliers ω and ν are corrected.

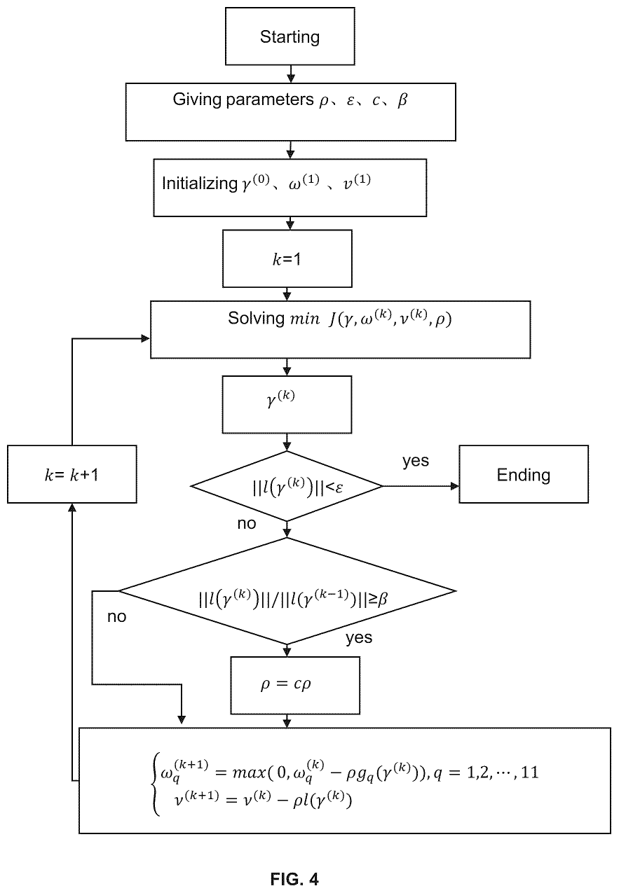

FIG. 4 is a basic flowchart of an exemplary process of a multiplier technique according to some embodiments of the present disclosure.

In some embodiments, the multiplier technique may include:
Step a: an initial point γ⁽⁰⁾, multiplier vectors initial estimates ω⁽¹⁾ and ν⁽¹⁾, a penalty parameter ρ, an allowable error ε>0, a constant c>1, β∈(0,1), k=1 are given;
Step b: an unconstrained problem shown in an equation (26) may be solved with γ^{(k-1)} as an initial point to obtain a solution γ^{(k-1)}. That is, starting from γ⁽⁰⁾, solving the equation (26) to obtain γ^{(k)}. When k=1, starting from γ⁽⁰⁾, solving the equation (26) to obtain γ⁽¹⁾.

$$min J ( γ , {ω}^{( k )} , {v}^{( k )} , ρ ) \qquad ( 26 )$$

Step c: in response to determining that ∥l(γ^{(k)})∥<ε, computation may be stopped and a point γ^{(k)} may be obtained, otherwise, proceeding to step d;
Step d: in response to determining that ∥l(γ^{(k)})∥/∥l(γ^{(k-1)})∥≥β, setting ρ=cρ and proceeding to step e, otherwise, proceeding to step e directly;
Step e: multipliers ω_{q}^{k+1} and ν^{(k+1)} may be corrected using the correction equation (25), setting k=k+1, and returning to step b.

In summary, as shown in FIG. 4, a basic process of the multiplier technique is as follows: the process starts, the parameters ρ, ε, c, and β are given, γ⁽⁰⁾, ω⁽¹⁾, and ν⁽¹⁾ are initialized and let k=1. minJ(γ, ω^{(k)}, ν^{(k)}, ρ) is solved, obtaining γ^{(k)}. Whether ∥l(γ^{(k)})∥ is less than ε is determined (i.e., whether a norm of the equality constraint l of γ^{(k)} is less than the allowable error ε is determined), if yes, the process ends; if not, it is determined whether ∥l(γ^{(k)})∥/∥(γ^{(k-1)})∥/ is greater than or equal to β. If ∥(γ^{(k)}∥/∥l(y^{(k-1)})∥/ is greater than or equal to β, let ρ=cρ (where the value of ρ may be gradually increased to better approximate the constraints of the original problem, hence the constant c>1), and the multipliers ω_{q}^{k+1} and ν^{(k+1)} are corrected using the correction equation (25); if ∥l(γ^{(k)})∥/∥l(γ^{(k-1)})∥/ is less than β, the multipliers ω_{q}^{k+1} and ν^{(k+1)} are corrected directly using the correction equation (25). Let k=k+1, minJ(γ, ω^{(k)}, ν^{(k)}, ρ) is solved iteratively and subsequent process are repeated until γ^{(k)} satisfies ∥l(γ^{(k)})∥<ε, and the process ends.

In some embodiments, the initial point γ⁽⁰⁾ and/or the constant c may be determined in a variety of ways. For example, the initial point γ⁽⁰⁾ and/or the constant c may be preset manually based on experience or by system default.

In some embodiments, the processor may extract a harmonic characteristic based on the harmonic characteristic dataset X and determine the initial point γ⁽⁰⁾ and/or the constant c based on the harmonic characteristic through vector matching.

The harmonic characteristic refers to relevant feature data of the harmonic characteristic dataset X. For example, the harmonic characteristic may include a maximum value, a minimum value, a total count of sampling points N, a historical first stable sequence, and a historical second stable sequence of a harmonic current Iₕ in the harmonic characteristic dataset X.

In some embodiments, the processor may extract the harmonic characteristic based on the harmonic characteristic dataset X through direct extraction and statistical determination. For example, the processor may directly extract the maximum value, the minimum value, and the total count of sampling points N of the harmonic currents Iₕ in the harmonic characteristic dataset X, and determine, through a statistical determination, the historical first stable sequence and the historical second stable sequence. More descriptions of the historical first stable sequence and the historical second stable sequence may be found in FIG. 2 and the related descriptions thereof.

In some embodiments, the processor may construct a vector database based on historical data, the vector database including a plurality of reference vectors and a reference initial point γ⁽⁰⁾ and/or a reference constant c corresponding to each of the plurality of reference vectors. One reference vector is constructed from the maximum value, the minimum value, the total count of sampling points N, the historical harmonic currents, the historical first stable sequence, and the historical second stable sequence in one historical harmonic characteristic dataset. Each reference vector may characterize its corresponding historical harmonic characteristic. The reference initial point γ⁽⁰⁾ and/or the reference constant c may be a historical actual initial point γ⁽⁰⁾ and/or a historical actual constant c corresponding to the historical harmonic characteristic. The reference vectors in the vector database are required to satisfy a preset requirement. The preset requirement may be that the actual count of corrections corresponding to the reference vectors is less than a preset threshold. The preset threshold may be manually determined based on prior experience or historical data.

In some embodiments, the processor may construct a target vector based on the harmonic characteristic. The processor may retrieve a reference vector in the vector database that has a smallest vector distance from the target vector, and determine the reference initial point γ⁽⁰⁾ and/or the reference constant c corresponding the reference vector as a current initial point γ⁽⁰⁾ and/or a current constant c. The vector distance may be any of a Euclidean distance, a cosine distance, a Mahalanobis distance, etc.

In some embodiments of the present disclosure, vector matching allows for rapid selection of a suitable initial point γ⁽⁰⁾ and/or a constant c, resulting in a lower count of corrections in the multiplier technique, thus reducing computational complexity and save computing resources.

In some embodiments, the processor may predict the initial point γ⁽⁰⁾ and/or the constant c based on the harmonic characteristic dataset X using a prediction model.

The prediction model refers to a model configured to determine the initial point γ⁽⁰⁾ and/or the constant c. In some embodiments, the prediction model may be a machine learning model such as a neural networks (NN) model, or the like.

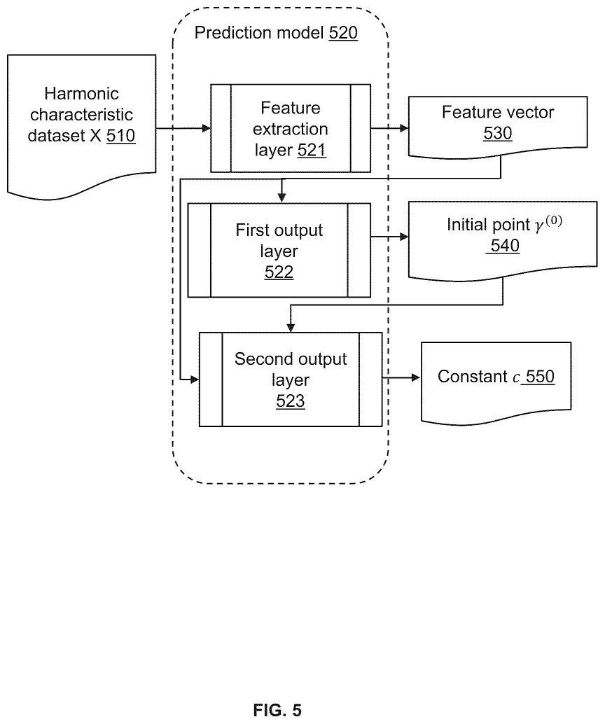

In some embodiments, as shown in FIG. 5, a prediction model 520 may include a feature extraction layer 521, a first output layer 522, and a second output layer 523. An input of the feature extraction layer 521 may include a harmonic characteristic dataset X (510) and an output of the feature extraction layer 521 may include a feature vector 530. An input of the first output layer 522 may include the feature vector 530 and an output of the first output layer 522 may include an initial point γ⁽⁰⁾ (540). An input of the second output layer 523 may include the feature vector 530 and the initial point γ⁽⁰⁾ (540) and an output of the second output layer 523 may include a constant c (550).

The feature extraction layer 521 refers to a model configured to determine the feature vector. In some embodiments, the feature extraction layer may be a machine learning model, e.g., a deep neural networks (DNN) model.

The feature vector 530 refers to a vector that characterizes a feature of the target harmonic data. In some embodiments, the feature vector may be an implicit feature vector.

The first output layer 522 refers to a model configured to determine the initial point γ⁽⁰⁾. In some embodiments, the first output layer 522 may be a machine learning model, such as a neural network (NN) model.

The second output layer 523 refers to a model configured to determine the constant c. In some embodiments, the second output layer 523 may be a machine learning model, such as a neural network (NN) model.

In some embodiments of the present disclosure, a more appropriate initial point γ⁽⁰⁾ and/or constant c may be quickly and accurately selected by the prediction model (e.g., the machine learning model), thereby optimizing the count of corrections in the multiplier technique and conserving computational resources.

In some embodiments, a training process of the prediction model may include: a plurality of sets of historical data satisfying a second preset condition are selected as training samples, wherein each training sample corresponds to a set of training labels. The set of training labels includes a first training label and a second training label. The first training label and the second training label are determined by the historical actual initial point γ⁽⁰⁾ and the historical actual constant c corresponding to the training sample, respectively.

In some embodiments, the historical data may be a historical harmonic characteristic dataset.

The second preset condition refers to a condition for determining whether the historical data may be used as the training samples. In some embodiments, the second preset condition may be that the actual count of corrections is less than the preset threshold. That is, the second preset condition may be the same as the preset requirement to be met by the reference vectors in the vector database described above.

In some embodiments, the feature extraction layer, the first output layer, and the second output layer of the prediction model are jointly trained, and parameters of the feature extraction layer, the first output layer, and the second output layer are updated simultaneously.

In some embodiments, the processor may input the training samples into the feature extraction layer to obtain a sample feature vector, input the sample feature vector into the first output layer to obtain a sample initial point γ⁽⁰⁾, determine a first difference between the sample initial point γ⁽⁰⁾ and the first training label, and define a product of a total harmonic voltage distortion rate or a total harmonic current distortion rate and the first difference as a first loss term. The processor may input the sample feature vector and the sample initial point γ⁽⁰⁾ into the second output layer to obtain a constant c, determine a second difference between the constant c and the second training label, and define a product of the total harmonic voltage distortion rate or the total harmonic current distortion rate and the second difference as a second loss term. The processor may determine a loss function for the joint training by performing a weighted sum of the first loss term and the second loss term. Weights of the weighted sum may be set manually based on experience. More descriptions of the total harmonic voltage distortion rate and the total harmonic current distortion rate may be found in FIG. 2 and the related descriptions thereof.

The first difference refers to a difference between the sample initial point γ⁽⁰⁾ and the historical actual initial point γ⁽⁰⁾, for example, a length of a vector formed by the difference between each element of the sample initial point γ⁽⁰⁾ and the historical actual initial point γ⁽⁰⁾, etc.

By way of example, the sample initial point γ⁽⁰⁾ is {λ₁⁽⁰⁾, λ₂⁽⁰⁾, λ₃⁽⁰⁾, μ₁⁽⁰⁾, μ₂⁽⁰⁾, σ₁⁽⁰⁾, σ₂⁽⁰⁾}, and the historical actual initial point γ⁽⁰⁾ is {λ₁^{(0)!}, λ₂^{(0)!}, λ₃^{(0)!}, μ₁^{(0)!}, μ₂^{(0)!}, σ₁^{(0)!}, σ₂^{(0)!}}, then the first difference may be the length of the vector [λ₁⁽⁰⁾−λ₁^{(0)!}, λ₂⁽⁰⁾−λ₂^{(0)!}, λ₃⁽⁰⁾−λ₃^{(0)!}, μ₁⁽⁰⁾−μ₁^{(0)!}, μ₂⁽⁰⁾−μ₂^{(0)!}, σ₁⁽⁰⁾−σ₁^{(0)!}, σ₂⁽⁰⁾−σ₂^{(0)!}].

The second difference refers to a difference between the constant c and the historical actual constant c, for example, the difference in values, absolute values, etc., of the constant c and the historical actual constant c.

In some embodiments, the processor may pre-divide the total harmonic voltage distortion rate or the total harmonic current distortion rate into a plurality of intervals, and an interval with a higher total harmonic voltage distortion rate or a higher total harmonic current distortion rate corresponds to a greater count of training samples.

In some embodiments, the processor may iteratively update the parameters of the feature extraction layer, the first output layer, and the second output layer at the same time based on the loss function of the joint training through gradient descent or other techniques. Training is determined completed when a third preset condition is satisfied, and a trained prediction model is obtained. The third preset condition may be that the loss function converges, a count of iterations reaches a threshold, or the like.

In some embodiments of the present disclosure, the different output layers of the prediction model can accurately and efficiently predict the initial points γ⁽⁰⁾ and/or the constants c corresponding to different harmonic characteristic datasets, which facilitates smooth operation of the multiplier technique and minimizing the count of corrections in the solution process.

In some embodiments, the input of the prediction model may further include at least one of a fundamental voltage, an active power, a reactive power, an apparent power, a total harmonic voltage distortion rate, a total harmonic current distortion rate, a statistic of a harmonic ratio of a 2nd to 25th harmonic voltage, and a statistic of effective values of a 2nd to 25th harmonic current.

More about the above parameters may be found in FIG. 2 and the related descriptions thereof.

In some embodiments of the present disclosure, the combination of other types of harmonic monitoring data can result in more accurate model output.

In some embodiments, the input of the prediction model may further include a type of the industrial load.

More descriptions of the type of the industrial load may be found in FIG. 2 and the related descriptions thereof.

In some embodiments of the present disclosure, incorporating the type of the industrial load enables the model output to be better suited to the industrial load.

In some embodiments of the present disclosure, the multiplier technique enables accurate and convenient determination of the solution γ^{(k)} of the unconstrained problem, achieving an optimal solution for the parameter of the discretized initial generalized probabilistic model, thereby determining the parameter of the generalized probabilistic model.

In some embodiments of the present disclosure, by discretizing the initial generalized probability model and constructing the parameter optimization model for the discretized initial generalized probability model, optimization of the parameter for the initial generalized probability model is achieved, which facilitates the development of a generalized probability model with high accuracy and adaptability for different industrial loads.

One or more embodiments of the present disclosure provide a device for monitoring and adjustment a harmonic emission level of an industrial load. The device may include at least one storage medium and at least one processor, wherein the at least one storage medium may be configured to store one or more sets of computer instructions and the at least one processor may be configured to execute the one or more sets of computer instructions or a portion thereof to implement the method for monitoring and adjusting the harmonic emission level of the industrial load.

One or more embodiments of the present disclosure provide a non-transitory computer-readable storage medium. The storage medium may store one or more sets of computer instructions, and when a computer reads the one or more sets of computer instructions, the computer executes the method for monitoring and adjusting the harmonic emission level of the industrial load.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for monitoring and adjusting a harmonic emission level of an industrial load, wherein the method is executed by a processor, and the method comprises:
obtaining, based on a power monitoring device deployed in a target region, a grid load for a current time period, wherein at least one type of industrial load is operating in the target region;
determining, for each of the at least one type of industrial load, a generalized probabilistic model for the industrial load through operations including:
obtaining, based on a power quality monitoring device deployed at at least one preset location around the industrial load, harmonic monitoring data of the industrial load at a preset frequency, wherein the at least one preset location includes a wire coupling position of the industrial load and the preset frequency is determined based on the grid load at the current time period;
determining, based on the harmonic monitoring data, a harmonic characteristic dataset for the industrial load, the harmonic characteristic dataset including at least one piece of target harmonic data;
constructing an initial generalized probabilistic model for the target harmonic data; and
obtaining the generalized probabilistic model for the target harmonic data by optimizing a parameter of the initial generalized probabilistic model;
determining, based on the generalized probabilistic model for the target harmonic data, a harmonic impact factor of the industrial load;
in response to determining that the harmonic impact factor of the industrial load satisfies a first preset condition, generating an adjustment instruction and sending the adjustment instruction to a control device to adjust the at least one type of industrial load operating in the target region, wherein the adjustment instruction includes a first adjustment instruction configured to control a target industrial load to reduce a count of electricity consumption devices and a second adjustment instruction configured to cut off a power supply of the target industrial load.

2. The method of claim 1, wherein the target harmonic data is a harmonic current and the determining, based on the harmonic monitoring data, a harmonic characteristic dataset for the industrial load includes:
constructing the harmonic characteristic dataset X by extracting the harmonic monitoring data of the industrial load, the harmonic characteristic dataset X being represented as:
$$X = [ \begin{matrix}{I}_{2}^{1} & {I}_{3}^{1} & … & {I}_{25}^{1} \\ {I}_{2}^{2} & {I}_{3}^{2} & … & {I}_{25}^{2} \\ ⋮ & ⋮ & ⋮ & ⋮ \\ {I}_{2}^{N} & {I}_{3}^{N} & … & {I}_{25}^{N}\end{matrix} ]$$
wherein, N represents a total count of sampling points, each column vector in X represents a harmonic current monitoring sequence of an order, I represents the harmonic current, the subscript of I represents a harmonic order, and the superscript of I represents a sampling sequence number.

3. The method of claim 2, wherein the total count of sampling points N is determined based on at least one of an average value of historical harmonic currents, a historical first stable sequence, and a historical second stable sequence in a preset historical time period.

4. The method of claim 2, wherein the harmonic order, represented as h, is determined based on at least one of an average value of historical harmonic currents, a historical first stable sequence, and a historical second stable sequence in a preset historical time period.

5. The method of claim 2, wherein the constructing an initial generalized probabilistic model for the target harmonic data includes:
constructing the initial generalized probabilistic model ƒ(Iₕ) for the target harmonic data in the harmonic characteristic dataset, the initial generalized probabilistic model ƒ(Iₕ) being represented as:
$$f ( {I}_{h} ) = {\sum }_{i = 1}^{3} {λ}_{i} {f}_{i} ( {I}_{h} )$$
wherein ƒᵢ(·) represents a sub-probability density function, λᵢ represents a weight coefficient of the sub-probability density function, Iₕ represents an h-th harmonic current, the initial generalized probabilistic model is a linear combination of three sub-probability density functions, ƒ₁(·) represents a portion of Iₕ obeying a normal distribution, ƒ₂(·) represents a portion of Iₕ obeying a lognormal distribution, ƒ₃(·) represents a portion of Iₕ obeying another distribution, and ƒᵢ(·) is represented as:
$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} \\ {f}_{2} ( {I}_{h} ) = \frac{1}{\sqrt{2 π} {I}_{h} {σ}_{2}} {e}^{- \frac{{( {lnI}_{h} - {μ}_{2} )}^{2}}{2 {σ}_{2}^{2}}} \\ {f}_{3} ( {I}_{h} ) = \frac{1}{nb} {\sum }_{j = 1}^{n} K ( \frac{{I}_{h} - {I}_{h}^{j}}{b} )$$
wherein μ₁ and μ₂ represent mathematical expectations of the sub-probability density function, σ₁ and σ₂ represent standard deviations of the sub-probability density function, K(·) represents a kernel function, b>0, b represents a smoothing parameter referred to as a bandwidth or a window, Iₕ^{j} represents a j-th sample of Iₕ in each window, and n represents a total count of samples in each window; and
the weight coefficient of the sub-probability density function satisfies the following equation:
$${\sum }_{i = 1}^{3} {λ}_{i} = 1 ( 0 \leq {λ}_{i} \leq 1 )$$
wherein λ₁=1 or λ₁=2, indicating that Iₕ obeys a single normal distribution or a lognormal distribution.

6. The method of claim 2, wherein the obtaining the generalized probabilistic model for the target harmonic data by optimizing a parameter of the initial generalized probabilistic model includes:
discretizing the initial generalized probabilistic model to obtain a discretized initial generalized probabilistic model ƒ(Ĩₕ):
$$f ( {\tilde{I}}_{h} ) = {\sum }_{i = 1}^{3} {λ}_{i} {f}_{i} ( {\tilde{I}}_{h} ) , {\tilde{I}}_{h} = 0 : 0.01 : max ( {I}_{h} )$$
wherein max(Iₕ) represents a maximum value of an h-th harmonic current, and Ĩₕ represents a discretized h-th harmonic current;
constructing a parameter optimization model for the discretized initial generalized probabilistic model through operations including:
constructing objective functions min y₁, min y₂, and min y:
$$min {y}_{1} = {( {\sum }_{i = 1}^{3} {λ}_{i} {E}_{i} ( {\tilde{I}}_{h} ) - {E}_{0} ( {\tilde{I}}_{h} ) )}^{2} \\ min {y}_{2} = {( \sqrt{{\sum }_{i = 1}^{3} {λ}_{i}^{2} {Var}_{i} ( {\tilde{I}}_{h} )} - \sqrt{{Var}_{0} ( {\tilde{I}}_{h} )} )}^{2}$$
wherein y₁ and y₂ represent mean square errors of an mathematical expectation and a standard deviation of the discretized initial generalized probabilistic model, respectively; Eᵢ(Ĩₕ) and E₀(Ĩₕ) represent a mathematical expectation of Ĩₕ computed from a sub-probability density function and an actual mathematical expectation of Ĩₕ, respectively; Varᵢ(Ĩₕ) and Var₀(Ĩₕ) represent a standard deviation of Ĩₕ computed from the sub-probability density function, and an actual standard deviation of Ĩₕ, respectively;
combining the objective functions min y₁ and min y₂ into a single minimized objective function, the combined minimized objective function is represented as:
$$min y = \frac{{y}_{1} + {y}_{2}}{2}$$
determining constraints, the constraints including an equality constraint l and an inequality constraint g_{q}, wherein the equality constraint l=Σᵢ₌₁³λᵢ−1=0 is used for optimizing a weight coefficient λᵢ of the sub-probability density function, the inequality constraint g_{q} includes a value range of the weight coefficient λᵢ and a value range of a random variable Ĩₕ determined by a numerical characteristic (μ₁, σ₁), (μ₂, σ₂) of the random variable Ĩₕ under an action of a single sub-probability density function;
the inequality constraint for λᵢ is represented as:
$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix}$$
assuming the 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈], and the inequality constraint for optimality-seeking variables {μ₁, μ₂, σ₁, σ₂} are represented as:
$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix} \\ \{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix} \\ \{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix} \\ \{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix}$$
wherein g_{q} represents the inequality constraint and q=1, 2, . . . , 11;
obtaining the generalized probabilistic model for the target harmonic data by optimizing the parameter of the initial generalized probabilistic model and determining a parameter of the generalized probabilistic model through operations including:
transforming a constrained problem into an unconstrained problem, using a multiplier technique to solve the unconstrained problem by setting a set of optimization-seeking variables to be γ={λ₁, λ₂, λ₃, μ₁, μ₂, σ₁, σ₂} and defining an augmented Lagrangian function as J, the augmented Lagrangian function J is represented as:
$$J ( γ , ω , v , ρ ) = y ( γ ) - vl ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \}$$
wherein y(γ) represents the objective function, l(γ) represents the equality constraint, g_{q}(γ) represents the inequality constraint, ω_{g} represents a Lagrange multiplier of an inequality constraint part, and ν represents a Lagrange multiplier of an equality constraint part, ρ represents a penalty parameter;
for J(γ, ω, ν, ρ), a locally optimal solution is obtained by taking a sufficiently large penalty parameter ρ and minimizing J(γ, ω, ν, ρ) through iterative correction of the multipliers ω and ν, where a correction equation for the multipliers ω and ν is represented as:
$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix}$$
wherein the superscript k represents a count of corrections.

7. The method of claim 6, wherein the objective function,
$${E}_{1} ( {\tilde{I}}_{h} ) = {μ}_{1} , {Var}_{1} ( {\tilde{I}}_{h} ) = {σ}_{1}^{2}$$
$${E}_{2} ( {\tilde{I}}_{h} ) = {e}^{{μ}_{2} + {σ}_{2}^{2} / 2} , {Var}_{2} ( {\tilde{I}}_{h} ) = ( {e}^{{σ}_{2}^{2}} - 1 ) {e}^{2 {μ}_{2} + {σ}_{2}^{2}}$$
$${E}_{3} ( {\tilde{I}}_{h} ) = {\sum }_{j = 1}^{{N}_{1}} {\tilde{I}}_{h}^{j} p ( {\tilde{I}}_{h}^{j} )$$
$${Var}_{3}^{j} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} )$$
$${N}_{1} = length ( {\tilde{I}}_{h} )$$
$$p ( {\tilde{I}}_{h}^{j} ) = \frac{{f}_{3} ( {\tilde{I}}_{h}^{j} )}{sum ( {f}_{3} ( {\tilde{I}}_{h} ) )}$$
wherein length(Ĩₕ) represents a length of Ĩₕ, p(Ĩₕ) represents a probability of Ĩₕ obeying another distribution, and p(Ĩₕ^{j}) represents a probability of Ĩₕ^{j} obeying another distribution.

8. The method of claim 6, wherein the multiplier technique includes:
step a: given an initial point γ⁽⁰⁾, multiplier vectors initial estimates ω⁽¹⁾ and ν⁽¹⁾, penalty parameter ρ, an allowable error ε>0, a constant c>1, β∈(0,1), k=1;
step b: solving an unconstrained problem shown in the following equation with γ^{(k-1)} as the initial point to obtain a solution γ^{(k-1)};
$$min J ( γ , {ω}^{( k )} , {v}^{( k )} , ρ )$$
step c: in response to determining that ∥l(γ^{(k)})∥<ε, stopping computation and obtaining a point γ^{(k)}, otherwise, proceeding to step d;
step d: in response to determining that ∥l(γ^{(k)})∥/∥l(γ^{(k-1)})∥≥β, setting ρ=cρ and proceeding to step e, otherwise, proceeding to step e directly;
step e: correcting multipliers ω_{q}^{k+1} and ν^{(k+1)} using the correction equation, setting k=k+1, and returning to step b.

9. The method of claim 8, wherein the method further includes:
extracting, based on the harmonic characteristic dataset X, a harmonic characteristic;
determining, based on the harmonic characteristic, the initial point γ⁽⁰⁾ and/or the constant c through vector matching.

10. The method of claim 8, wherein the method further comprises:
predicting, based on the harmonic characteristic dataset X, the initial point γ⁽⁰⁾ and/or the constant c using a prediction model, the prediction model being a machine learning model;
the prediction model includes a feature extraction layer, a first output layer, and a second output layer, an input of the feature extraction layer includes the harmonic characteristic dataset X and an output of the feature extraction layer is a feature vector, an input of the first output layer includes the feature vector and an output of the first output layer is the initial point γ⁽⁰⁾, an input of the second output layer includes the feature vector and the initial point γ⁽⁰⁾ and an output of the second output layer is the constant c.

11. The method of claim 10, wherein a training process of the prediction model includes:
using a plurality of sets of historical data satisfying a second preset condition as a training sample, wherein the training sample corresponds to a set of training labels including a first training label and a second training label, the first training label and the second training label are determined by a historical actual initial point γ⁽⁰⁾ and a historical actual constant c corresponding to the training sample, respectively, the second preset condition includes a count of actual corrections being less than a preset threshold; and
jointly training the feature extraction layer, the first output layer, and the second output layer of the prediction model by updating parameters of the feature extraction layer, the first output layer, and the second output layer simultaneously.

12. The method of claim 10, wherein the input of the prediction model further includes: at least one of a fundamental voltage, an active power, a reactive power, an apparent power, a total harmonic voltage distortion rate, a total harmonic current distortion rate, a statistic of a harmonic ratio of a 2nd to 25th harmonic voltage, and a statistic of effective values of a 2nd to 25th harmonic current.

13. The method of claim 10, wherein the input of the prediction model further includes a type of the industrial load.

14. A system for monitoring and adjusting a harmonic emission level of an industrial load, comprising an acquisition module, a determination module, and an adjustment module, wherein
the acquisition module is configured to obtain, based on a power monitoring device deployed in a target region, a grid load for a current time period, wherein at least one type of industrial load is operating in the target region;
the determination module is configured to determine, for each of the at least one type of industrial load, a generalized probabilistic model for the industrial load, the determination module includes a data acquisition unit, a dataset determination unit, a model construction unit, a model determination unit, and a factor determination unit, wherein:
the data acquisition unit is configured to obtain, based on a power quality monitoring device deployed at at least one preset location around the industrial load, harmonic monitoring data of the industrial load at a preset frequency, wherein the at least one preset location includes a wire coupling position of the industrial load and the preset frequency is determined based on the grid load at the current time period;
the determination dataset unit is configured to determine, based on the harmonic monitoring data, a harmonic characteristic dataset for the industrial load, the harmonic characteristic dataset including at least one piece of target harmonic data;
the model construction unit is configured to constructing an initial generalized probabilistic model for the target harmonic data;
the model determination unit is configured to obtaining the generalized probabilistic model for the target harmonic data by optimizing a parameter of the initial generalized probabilistic model; and
the factor determination unit is configured to determine, based on the generalized probabilistic model for the target harmonic data, a harmonic impact factor of the industrial load; and
the adjustment module is configured to: in response to determining that the harmonic impact factor of the industrial load satisfies a first preset condition, generate an adjustment instruction and send the adjustment instruction to a control device to adjust the at least one type of industrial load operating in the target region, wherein the adjustment instruction includes a first adjustment instruction configured to control a target industrial load to reduce a count of electricity consumption devices and a second adjustment instruction configured to cut off a power supply of the target industrial load.

15. The system of claim 14, wherein the target harmonic data is a harmonic current and the data acquisition unit is further configured to:
construct the harmonic characteristic dataset X by extracting the harmonic monitoring data of the industrial load, the harmonic characteristic dataset X being represented as:
$$X = [ \begin{matrix}{I}_{2}^{1} & {I}_{3}^{1} & … & {I}_{25}^{1} \\ {I}_{2}^{2} & {I}_{3}^{2} & … & {I}_{25}^{2} \\ ⋮ & ⋮ & ⋮ & ⋮ \\ {I}_{2}^{N} & {I}_{3}^{N} & … & {I}_{25}^{N}\end{matrix} ]$$
wherein, N represents a total count of sampling points, each column vector in X represents a harmonic current monitoring sequence of an order, I represents the harmonic current, the subscript of I represents a harmonic order, and the superscript of I represents a sampling sequence number.

16. The system of claim 15, wherein the model construction unite is further configured to construct the initial generalized probabilistic model ƒ(Iₕ) for the target harmonic data in the harmonic characteristic dataset, the initial generalized probabilistic model ƒ(Iₕ) being represented as:
$$f ( {I}_{h} ) = {\sum }_{i = 1}^{3} {λ}_{i} {f}_{i} ( {I}_{h} )$$
wherein ƒᵢ(·) represents a sub-probability density function, λᵢ represents a weight coefficient of the sub-probability density function, Iₕ represents an h-th harmonic current, the initial generalized probabilistic model is a linear combination of three sub-probability density functions, ƒ₁(·) represents a portion of Iₕ obeying a normal distribution, ƒ₂(·) represents a portion of Iₕ obeying a lognormal distribution, ƒ₃(·) represents a portion of Iₕ obeying another distribution, and ƒᵢ(·) is represented as:
$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}}$$
$${f}_{2} ( {I}_{h} ) = \frac{1}{\sqrt{2 π} {I}_{h} {σ}_{2}} {e}^{- \frac{{( ln {I}_{h} - {μ}_{2} )}^{2}}{2 {σ}_{2}^{2}}}$$
$${f}_{3} ( {I}_{h} ) = \frac{1}{n b} {\sum }_{j = 1}^{n} K ( \frac{{I}_{h} - {I}_{h}^{j}}{b} )$$
wherein μ₁ and μ₂ represent mathematical expectations of the sub-probability density function, σ₁ and σ₂ represent standard deviations of the sub-probability density function, K(·) represents a kernel function, b>0, b represents a smoothing parameter referred to as a bandwidth or a window, Iₕ^{j} represents a j-th sample of Iₕ in each window, and n represents a total count of samples in each window; and
the weight coefficient of the sub-probability density function satisfies the following equation:
$${\sum }_{i = 1}^{3} {λ}_{i} = 1 ( 0 \leq {λ}_{i} \leq 1 )$$
wherein λ₁=1 or λ₁=2, indicating that Iₕ obeys a single normal distribution or a lognormal distribution.

17. The system of claim 15, wherein the model determination unit is further configured to discretize the initial generalized probabilistic model to obtain a discretized initial generalized probabilistic model ƒ(Ĩₕ):
$$f ( {\tilde{I}}_{h} ) = {\sum }_{i = 1}^{3} {λ}_{i} {f}_{i} ( {\tilde{I}}_{h} ) , {\tilde{I}}_{h} = 0 : 0.01 : max ( {I}_{h} )$$
wherein max(Iₕ) represents a maximum value of an h-th harmonic current, and Ĩₕ represents a discretized h-th harmonic current;
construct a parameter optimization model for the discretized initial generalized probabilistic model, and to construct the parameter optimization model, the model determination unit is further configured to:
construct objective functions min γ₁, min y₂, and min y:
$$min {{y}_{1} ( {\sum }_{i = 1}^{3} {λ}_{i} {E}_{i} ( {\tilde{I}}_{h} ) - {E}_{0} ( {\tilde{I}}_{h} ) )}^{2}$$
$$min {y}_{2} ( \sqrt{{\sum }_{i = 1}^{3} {λ}_{i}^{2} {Var}_{i} ( {\tilde{I}}_{h} )} - \sqrt{{{Var}_{0} ( {\tilde{I}}_{h} ) )}^{2}}$$
wherein y₁ and y₂ represent mean square errors of an mathematical expectation and a standard deviation of the discretized initial generalized probabilistic model, respectively; Eᵢ(Ĩₕ) and E₀(Ĩₕ) represent a mathematical expectation of Ĩₕ computed from a sub-probability density function and an actual mathematical expectation of Ĩₕ, respectively; Varᵢ(Ĩₕ) and Var₀(Ĩₕ) represent a standard deviation of Ĩₕ computed from the sub-probability density function, and an actual standard deviation of Ĩₕ;
combining the objective functions min y₁ and miny₂ into a single minimized objective function, the combined minimized objective function is represented as:
$$min y = \frac{{y}_{1} + {y}_{2}}{2}$$
determine constraints, the constraints including an equality constraint l and an inequality constraint g_{q}, wherein the equality constraint l=Σᵢ₌₁³−1=0 is used for optimizing a weight coefficient λᵢ of the sub-probability density function, the inequality constraint g_{q} includes a value range of the weight coefficient λᵢ and a value range of a random variable Ĩₕ determined by a numerical characteristic (μ₁, σ₁), (μ₂, σ₂) of the random variable Ĩₕ under an action of a single sub-probability density function;
the inequality constraint for Δᵢ is represented as:
$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix}$$
assuming the 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈], and the inequality constraint for optimality-seeking variables {μ₁, μ₂, σ₁, σ₂} are represented as:
$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix}$$
$$\{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix}$$
$$\{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix}$$
$$\{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix}$$
wherein g_{q} represents the inequality constraint and q=1, 2, . . . , 11;
obtain the generalized probabilistic model for the target harmonic data by optimizing the parameter of the initial generalized probabilistic model and determining a parameter of the generalized probabilistic model, and to obtain the generalized probabilistic model, the model determination unit is further configured to:
transform a constrained problem into an unconstrained problem, use a multiplier technique to solve the unconstrained problem by setting a set of optimization-seeking variables to be γ={λ₁, λ₂, λ₃, μ₁, μ₂, σ₁, σ₂} and define an augmented Lagrangian function as J, the augmented Lagrangian function J is represented as:
$$J ( γ , ω , v , ρ ) = y ( γ ) - v l ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \}$$
wherein y(γ) represents the objective function, l(γ) represents the equality constraint, g_{q}(γ) represents the inequality constraint, ω_{q} represents a Lagrange multiplier of an inequality constraint part, and v represents a Lagrange multiplier of an equality constraint part, ρ represents a penalty parameter;
for J(γ, ω, ν, ρ), a locally optimal solution is obtained by taking a sufficiently large penalty parameter ρ and minimizing J(γ, ω, ν, ρ) through iterative correction of the multipliers ω and ν, where a correction equation for the multipliers ω and ν is represented as:
$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix}$$
wherein the superscript k represents a count of corrections.

18. The system of claim 17, wherein the objective function,
$${E}_{1} ( {\tilde{I}}_{h} ) = {μ}_{1} , {Var}_{1} ( {\tilde{I}}_{h} ) = {σ}_{1}^{2}$$
$${E}_{2} ( {\tilde{I}}_{h} ) = {e}^{{μ}_{2} + {σ}_{2}^{2} / 2} , {Var}_{2} ( {\tilde{I}}_{h} ) = ( {e}^{{σ}_{2}^{2}} - 1 ) {e}^{2 {μ}_{2} + {σ}_{2}^{2}}$$
$${E}_{3} ( {\tilde{I}}_{h} ) = {\sum }_{j = 1}^{{N}_{1}} {\tilde{I}}_{h}^{j} p ( {\tilde{I}}_{h}^{j} )$$
$${Var}_{3}^{j} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} )$$
$${N}_{1} = length ( {\tilde{I}}_{h} )$$
$$p ( {\tilde{I}}_{h}^{j} ) = \frac{{f}_{3} ( {\tilde{I}}_{h}^{j} )}{sum ( {f}_{3} ( {\tilde{I}}_{h} ) )}$$
wherein length(Ĩₕ) represents a length of Ĩₕ, p(Ĩₕ) represents a probability of Ĩₕ obeying another distribution, and p(Ĩₕ^{j}) represents a probability of Ĩₕ^{j} obeying another distribution.

19. A device for monitoring and adjustment a harmonic emission level of an industrial load, comprising at least one storage medium and at least one processor, wherein the at least one processor is configured to execute the method for monitoring and adjusting the harmonic emission level of the industrial load according to claim 1.

20. A non-transitory computer-readable storage medium storing one or more sets of computer instructions, wherein when a processor executes the one or more sets of computer instructions, the method for monitoring and adjusting the harmonic emission level of the industrial load according to claim 1 is implemented.
